(19) United States
(12) Patent Application Publication
(10) Pub. No.: US 2026/0342600 A1
(43) Pub. Date: Oct. 29, 2026

(54) METHOD AND SYSTEM FOR IMPROVING AUTHORIZATION POLICY FRAMEWORK IN 5G NETWORK

(71) Applicant: Samsung Electronics Co., Ltd., Suwon-si, Gyeonggi-do (KR)

(72) Inventors: Varini GUPTA, Bangalore (IN); Narendranath Durga TANGUDU, Bangalore (IN)

(21) Appl. No.: 19/117,803

(22) PCT Filed: Sep. 27, 2023
(86) PCT No.: PCT/KR2023/015082

§ 371 Date: Apr. 2, 2025

(30) Foreign Application Priority Data
Oct. 3, 2022 (IN) 202241056839
Sep. 14, 2023 (IN) 2022 41056839

(51) Int. Cl. H04L 9/40; H04L 9/32

(52) U.S. Cl. CPC H04L 9/40; H04L 9/3213

(57) ABSTRACT

The disclosure relates to a 5G or 6G communication system for supporting a higher data transmission rate. A Network Function (NF) producer determines, based on a plurality of network attributes associated with a plurality of NF consumers, a plurality of authorization parameters indicating one or more first type of access-rights of a plurality of NF consumers that are authorized by the NF producer and/or one or more second types of access-rights of the plurality of NF consumers that are unauthorized by the NF producer, constructs, based on the determined plurality of authorization parameters, a policy profile including an authorization policy corresponding to each network attribute among the plurality of network attributes, and registers the constructed policy profile including the authorization policy into the NRF.

### TECHNICAL FIELD

The present disclosure generally relates to a field of wireless communication networks, more particularly relates to a method and system for improving authorization policy framework in 5th Generation (5G) networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

This summary is provided to introduce a selection of concepts, in a simplified format, that are further described in the detailed description of the disclosure. This summary is neither intended to identify key or essential inventive concepts of the invention nor is it intended to determine the scope of the disclosure.

Disclosed herein is a method implemented at a Network Function (NF) producer for registering authorization policies into a Network Repository Function (NRF) in a communication network. The method includes determining a plurality of authorization parameters indicating one or more first types of access-rights of a plurality of NF consumers that are authorized by the NF producer and/or one or more second types of access-rights of the plurality of NF consumers that are unauthorized by the NF producer. The plurality of authorization parameters is determined based on a plurality of network attributes associated with the plurality of NF consumers. The method further includes constructing a policy profile including an authorization policy corresponding to each network attribute among the plurality of network attributes. The policy profile is constructed based on the determined plurality of authorization parameters. Furthermore, the method includes registering the constructed policy profile including the authorization policy into the NRF.

Also disclosed herein is a method implemented at a Network Repository Function (NRF) of a communication network for allocating or denying an Access-Token to a Network Function (NF). The method includes receiving a request for the Access-Token from the NF consumer and thereafter determining one or more network attributes associated with the NF consumer in response to the received request. The method further includes mapping the determined one or more network attributes with one or more authorization rules that are registered by an NF producer into the NRF. Furthermore, the method includes determining a highest priority rule containing network attributes of the NF consumer based on the result of the mapping. Once the highest priority authorization rule is determined, thereafter the method includes determining at least one Access-Token claim based on a scope of authorization and action included in the highest priority authorization rule. Lastly, the method includes allocating the Access-Token to the NF consumer based on the at least one Access-Token claim.

Also disclosed herein is a method implemented at a Network Repository Function (NRF) of a communication network for allowing discovery of one or more Network Function (NF) producers. The method includes receiving a request for discovery of the one or more NF producers matching a set of capabilities from an NF consumer and thereafter determining one or more network attributes associated with the NF consumer in response to the received request. The method further includes mapping the determined one or more network attributes with one or more authorization rules that are registered by the or more NF producers into the NRF. Furthermore, the method includes determining a highest priority authorization rule containing network attributes of the NF consumer, based on a result of the mapping. Once the highest priority authorization rule is determined, thereafter the method includes whether an NF producer among the one or more NF producers and/or NF services of the NF producer are allowed or denied to be discovered by the NF consumer. Lastly, the method includes sending, by the NRF, a discovery result containing a list of NF producers and allowed NF services of NF producers that are included in the list. The allowed NF services are services that can be accessed by the NF consumer.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

These and other features, aspects, and advantages of the present disclosure will be understood better when the following detailed description is read with reference to the accompanying drawings in which like characters represent like parts throughout the drawings, wherein:

FIG. 1 illustrates a first example representation of an NF service producer registering the NF-profile containing authorization policy into the NRF using Nnrf_NFManagement service, according to an embodiment of the disclosure;

FIG. 2 illustrates a second example representation of NF service producers registering the NF-profile containing authorization policy into the NRF using Nnrf_NFManagement service, according to an embodiment of the disclosure;

FIG. 3 illustrates a first example representation depicting a registration process performed by the NF producer to register a policy profile for one or more PLMNs of NF consumers into the NRF, according to an embodiment of the disclosure;

FIG. 4 illustrates a second example representation depicting a registration process performed by the NF producer to register a policy profile into the NRF by providing additional authorization parameters, according to an embodiment of the disclosure;

FIG. 5 illustrates a third example representation depicting a registration process performed by the NF producer to register a policy profile into the NRF by providing additional authorization parameters, according to an embodiment of the disclosure;

FIG. 6 illustrates a line diagram depicting a method implemented at the NRF for allowing discovery of one or more NF producers, according to an embodiment of the disclosure;

FIG. 7 illustrates a line diagram depicting a method implemented at the NRF for allocating or denying an Access-Token to an NF consumer, according to an embodiment of the disclosure;

FIG. 8 illustrates a detailed method flow chart depicting the method for allocating or denying the Access-Token to the NF consumer in detail, according to an embodiment of the disclosure; and

FIG. 9 illustrates an example block diagram of a communication environment depicting a configuration of the NF producer and the NRF in a wireless communication network, according to an embodiment of the disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the con-struction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### MODE FOR THE INVENTION

For the purpose of promoting an understanding of the principles of the disclosure, reference will now be made to the various embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The terms “an embodiment”, “another embodiment”, “some embodiments”, or “in one or more embodiments” may refer to one embodiment, several embodiments, or all embodiments. Accordingly, the term “some embodiments” is defined as meaning “one embodiment, or more than one embodiment, or all embodiments.”

The terminology and structure employed herein are for describing, teaching, and illu-minating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “consisting,” “has,” and “have” and grammatical variants thereof do not specify an exact limitation or restriction and certainly do not exclude the possible addition of one or more features or elements, unless otherwise stated, and must not be taken to exclude the possible removal of one or more of the listed features and elements unless otherwise stated with the limiting language “mush comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more” or “one or more element is required.”

Unless otherwise defined, all terms, and especially any technical and/or scientific terms, used herein may be taken to have the same meaning as commonly understood by one having ordinary skill in the art.

The term “network attributes” corresponds to “properties of NF consumers” and is used interchangeably throughout the disclosure without deviating from the scope of the disclosure. Also, the terms “NF service-producer” and “NF producer” are the same and used interchangeably throughout the disclosure without deviating from the scope of the disclosure. Similarly, the terms “NF service-consumer” and “NF consumer” mean the same and are used interchangeably throughout the disclosure without deviating from the scope of the disclosure.

The term “authorized” corresponds to “allowed” and is used interchangeably throughout the disclosure without deviating from the scope of the disclosure.

The term “unauthorized” corresponds to “restricted” or “denied”, and is used interchangeably throughout the disclosure without deviating from the scope of the disclosure.

Now embodiments of the disclosure will be described below in detail with reference to the accompanying drawings.

Disclosed herein is a method implemented at a Network Function (NF) producer for registering authorization policies into a Network Repository Function (NRF) in a communication network. The method includes determining a plurality of authorization parameters indicating one or more first types of access-rights of a plurality of NF consumers that are authorized by the NF producer and/or one or more second types of access-rights of the plurality of NF consumers that are unauthorized by the NF producer. The plurality of authorization parameters is determined based on a plurality of network attributes associated with the plurality of NF consumers. The method further includes constructing a policy profile including an authorization policy corresponding to each network attribute among the plurality of network attributes. The policy profile is constructed based on the determined plurality of authorization parameters. Furthermore, the method includes registering the constructed policy profile including the authorization policy into the NRF.

Also disclosed herein is a method implemented at the NRF for allocating or denying an Access-Token to an NF consumer. The method includes receiving a request for the Access-Token from the NF consumer and thereafter determining one or more network attributes associated with the NF consumer in response to the received request. The method further includes mapping the determined one or more network attributes with one or more authorization rules that are registered by an NF producer into the NRF. Furthermore, the method includes determining a highest priority rule containing network attributes of the NF consumer based on the result of the mapping. Once the highest priority authorization rule is determined, thereafter the method includes determining at least one Access-Token claim based on a scope of authorization and action included in the highest priority authorization rule. Lastly, the method includes allocating the Access-Token to the NF consumer based on the at least one Access-Token claim.

Also disclosed herein is a method implemented at the NRF for allowing discovery of one or more NF producers. The method includes receiving a request for discovery of the one or more NF producers matching a set of capabilities from the NF consumer and thereafter determining one or more network attributes associated with the NF consumer in response to the received request. The method further includes mapping the determined one or more network attributes with one or more authorization rules that are registered by the or more NF producers into the NRF. Furthermore, the method includes determining a highest priority authorization rule containing network attributes of the NF consumer, based on a result of the mapping. Once the highest priority authorization rule is determined, thereafter the method includes whether an NF producer among the one or more NF producers and/or NF services of the NF producer are allowed or denied to be discovered by the NF consumer. Lastly, the method includes sending, by the NRF, a discovery result containing a list of NF producers and allowed NF services of NF producers that are included in the list. The allowed NF services are services that can be accessed by the NF consumer.

3rd Generation Partnership Project (3GPP) Release 15 introduced service-based architecture for 5G-core that involves a set of inter-connected Network Functions (NFs), and an authorization framework to request and grant access to each other's services. The authorization framework uses the OAuth 2.0 framework as specified in RFC-6749, whereby authorization tokens (also called access tokens) are granted to NF service consumers, with each access token defining a scope of authorization.

Network Repository Function (NRF) plays the role of OAuth 2.0 authorization server. The NRF exposes Nnrf_AccessToken service which allows NF service consumers (OAuth 2.0 clients) to request an OAuth2 access token from the NRF, to access services offered by NF service producers (OAuth 2.0 resource server).

The NRF also exposes the Nnrf_NFManagement service, which allows the NF service producers to register a profile in the NRF. The profile includes the services offered by the NF service producers, and information about the NF service consumer's properties such as Public Land Mobile Networks (PLMNs), Stand-alone Non-Public Networks (SNPNs), Network Function Types (NF-Type), Network Function Domains (NF-Domain), Single Network Slice Selection Assistance Information (S-NSSAIs), etc. The profile may also contain an authorization policy including rules for example, “which NFs are allowed to access them” and “what are they allowed to access”.

For example, the profile contains parameters as shown in Table 1 below:

TABLE 1

| | |
|---|---|
| allowedPlmns | NFs from specific PLMNs are allowed to access the nf/nf-service instance |
| allowedSnpns | NFs from specific SNPNs are allowed to access the nf/nf-service instance |
| allowedNfTypes | NFs of specific types are allowed to access the nf/nf-service instance |
| allowedNfDomains | NFs of specific domains are allowed to access the nf/nf-service instance |
| allowedNssais | NFs of specific S-NSSAI are allowed to access the nf/nf-service instance |
| allowedOperationsPerNfType | NFs of specific types are allowed specific operations on resources of the nf-service instance |
| allowedOperationsPerNfInstance | Specific NFs are allowed specific operations on resources of the nf-service instance |

The rule “which NFs are allowed to access” in the authorization policy identifies properties such as PLMN, SNPN, NF-Type, NF-Domain, S-NSSAIs, etc., of the NF service consumers which may be allowed to access the NF service producer.

The rule “what are they allowed to access” in the authorization policy identifies “scope” or authorization. The scope defines a set of resource identifiers in an NF service producer and the type of access allowed. For example, if an NF service consumer is only allowed to “read” a resource representation URI1 in the NF Service producer, the NF Service Producer can register the scope as “URI1: read” against such NF service consumer. Based on this scope, the NF service consumer will not be allowed to update (overwrite) URI1 information in the NF service producer as it does not have “write” permissions to URI1. Similarly, this NF service consumer will not be allowed to read other resources (e.g., URI2) as it does not have permission to access those. If, on the other hand, the NF service producer wishes to allow all its NF service consumers to access everything, it does not need to register resource-specific scopes.

If an NF service producer's profile contains more than one authorization parameter from Table 1 as shown above, the NRF performs a logical ‘AND’ operation among them to determine the overall authorization policy. If, for example, the profile contains allowedPlmns and allowedNfTypes, the NRF ensures that the NF service consumers requesting access belong to one of the listed PLMNs and that their NfType is one of those allowed by the NF service producers.

The NRF also allows the NF service consumers to discover other NF-Instances with the potential services they offer, by querying the NRF using the Nnrf_NFDiscovery service. When the NF service consumers wish to utilize the services offered by the NF service producers and utilize these services to discover the NF service producers, the NRF uses the above-mentioned authorization parameters to validate if the NF service consumers are allowed to access the requested service in the NF service producers, before providing a discovery response.

In the current state of the art, if the NF service producer wishes to restrict a specific or small number of the NF service consumers to certain operations/scopes, the NF service producer needs to populate the allowedOperationsPerNfType and/or allowedOperationsPerNfInstance parameters with the allowed operations of all the other allowed NF-Types and/or NF-Instances as well, even if there is no restriction on remaining NF service consumers. This creates huge authorization information to be registered as part of the allowedOperationsPerNfType and/or allowedOperationsPerNfInstance parameters. This disadvantage of creating huge authorization information just to restrict a couple of NF service consumers poses a significant configuration and management burden on the NF service producers and also a significant amount of authorization information that needs to be registered, processed, and maintained in the NRF.

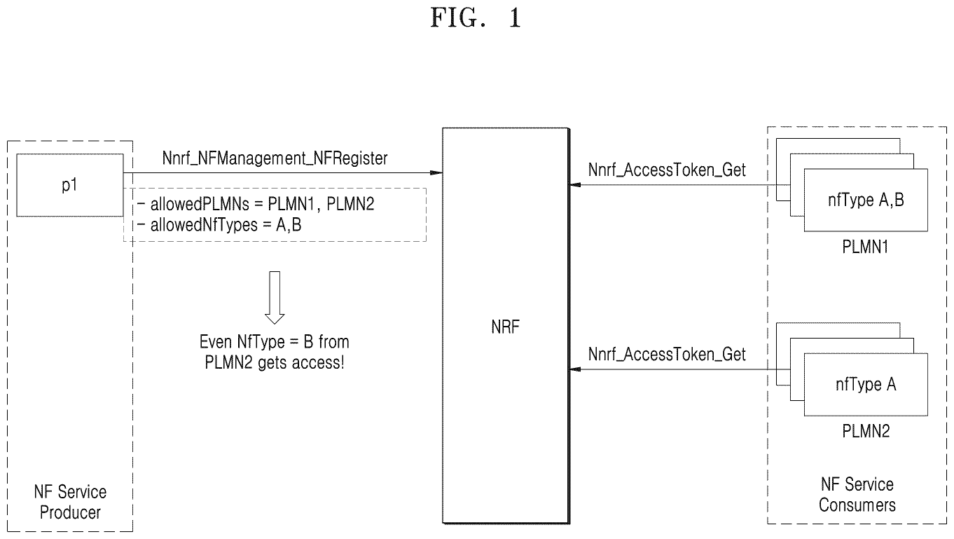

FIG. 1 illustrates a first example representation of the NF service producer registering the NF-profile containing authorization policy into the NRF using Nnrf_NFManagement service, according to an embodiment of the disclosure. In an example as shown in FIG. 1, the NF service producer p1 has no conflicting policy among authorization parameters as indicated in Table 1 above. In the example, the NF service producer p1 allows NF service consumers of PLMN1 of nfType=A or nfType=B to access its resources, unrestricted. However, the NF service producer p1 only allows NF service consumers of PLMN2 of nfType=A to access its resources, unrestricted. In particular, no NF service consumer of PLMN2 other than nfType=A is allowed to access the resources of the NF service producer p1. Hence, the NF service producer p1 registers nf-profile into the NRF, using Nnrf_NFManagement_NFRegister service operation, or using Nnrf_NFManagement_NFUpdate service operation, with authorization policy containing allowedNfTypes={A, B} corresponding to allowedPlmns=PLMN1, PLMN2. In such a case, even the NF service consumer of PLMN2 of NfType=B gets access to the resources that are restricted by the NF service producer p1.

Thus, there is a need to optimize the authorization policy registered by the NF service producers to restrict the access of the resources for any specific service type (i.e., for example, NfType=B) of the NF service consumer of a specific PLMN (i.e., for example, PLMN2), for which the NF service producers have intended to restrict access of their resources.

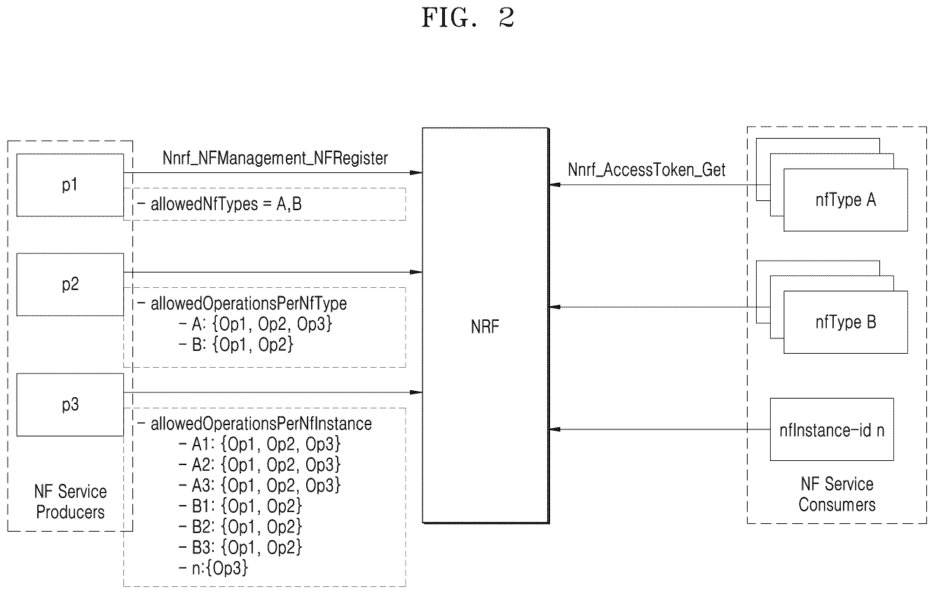

FIG. 2 illustrates a second example representation of NF service producers registering the NF-profile containing authorization policy into the NRF using Nnrf_NFManagement service, according to an embodiment of the disclosure.

In an example representation as shown in FIG. 2, the NF service producers p1, p2, and p3 may have no conflicting policy among the authorization parameters as indicated in Table 1 above. In the example, the scope of access is identified by Op1, Op2, and Op3, which are a set of resource representations and access permissions. An NF service producer p1 allows all NF service consumers with nfType=A or nfType=B to access its resources, unrestricted. No NF service consumer of any other nfType is allowed to access it. Hence, p1 registers its nf-profile into NRF, using Nnrf_NFManagement_NFRegister service operation, or using Nnrf_NFManagement_NFUpdate service operation, with authorization policy containing allowedNfTypes={A, B}. No resource-specific scopes (Op1, Op2, Op3) need to be registered.

Further, as shown in FIG. 2, the NF service producer p2 allows all NF service consumers with nfType=A to access its resources unrestricted. However, the NF service producer p2 does not allow the NF service consumers with nfType=B to access its resources unrestricted. The NF service consumers with nfType=B are limited to Op1 and Op2. Hence, the NF service producer p2 needs to register, in its nf-profile into the NRF, an authorization policy containing allowedOperationsPerNfType={Op1, Op2} for nfType=B. Additionally, the NF service producer p2 needs to register, in its nf-profile into the NRF, an authorization policy containing allowedOperationsPerNfType={Op1, Op2, Op3} for nfType=A. The NF service producer p2 may use Nnrf_NFManagement_NFRegister service operation, or Nnrf_NFManagement_NFUpdate service operation to register the profile into the NRF.

Thus, even though all that the NF service producer p2 wanted was to restrict the NF service consumers with nfType=B to Op1 and Op2 while not restricting others, the NF service producer p2 now needs to register scope information about all its consumers. If, for example, there are more NF service consumers of nfType=C, D, E, . . . , Z, each of them needs to be configured with individual scope information irrespective of whether they are unrestricted or not.

Additionally, as shown in FIG. 2, the NF service producer p3 is in an even worse situation. The NF service producer p3 allows all NF service consumers with nfType=A to access its resources unrestricted and NF service consumers with nfType=B are limited to Op1 and Op2. Additionally, the NF service producer p3 wants to allow an NF service consumer with NF-Instance-ID=n to Op3 only. Accordingly, the NF service producer p3 needs to register, in its nf-profile into the NRF, an authorization policy containing allowedOperationsPerNfInstance={Op3} for nfInstanceID=n. Additionally, the NF service producer p3 needs to register, in its nf-profile into the NRF, an authorization policy containing allowedOperationsPerNfInstance={Op1, Op2, Op3}, individually for every NF with nfType=A, and an authorization policy containing allowedOperationsPerNfInstance={Op1, Op2}, individually for every NF with nfType=B. The NF service producer p3 may use Nnrf_NFManagement_NFRegister service operation, or Nnrf_NFManagement_NFUpdate service operation to register the profile into the NRF.

Thus, even though all the NF service producer p3 wanted was to restrict the NF service consumer with nfInstanceID=n to Op3, it now needs to register scope information about all its consumers. If, for example, there are a thousand NF service consumers of nfType=A, then each of them needs to be configured individually with the same scope information.

Consider, for example, a network may have hundreds of AMFs, each allowed to update the Nudm_UECM resource (e.g., . . . /nudm-uecm/v1/{ueId}/registrations/as defined in 3GPP TS 29.503 V17.8.0) in the UDM for individual UEs. However, if the network wants to allow a specific NF identified by an nf-instance-ID to know UE's current serving AMF by performing a GET operation on the above resource in UDM but does not want to provide it with write access, it will need to update UDM's authorization policy containing information about all the AMFs individually.

Thus, in view of the above-discussed example problems, there is a need to optimize the authorization policy registered by the NF service producers into the NRF. It is to be noted that the AMF in the above example is used to highlight the problem. The issue can be with any NF that just wants to restrict specific NF service consumers but not others.

Thus, it is desired to address the above-mentioned disadvantages or other shortcomings or at least provide a useful alternative to overcome the above-mentioned disadvantages associated with registering the NF-Profile containing the authorization policy into the NRF.

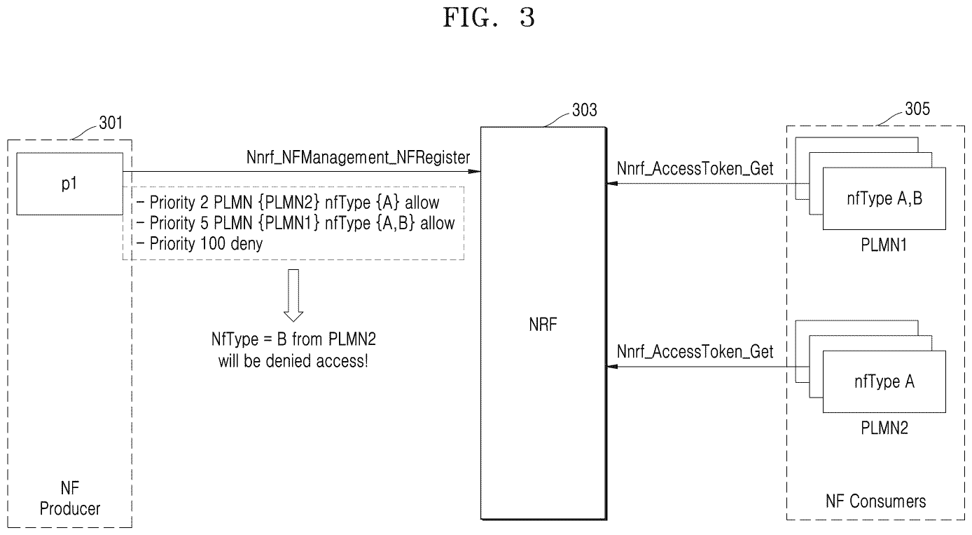

FIG. 3 illustrates a first example representation depicting a registration process performed by an NF service-producer 301 (also referred to as “NF producer 301”) to register a policy profile for one or more Public Land Mobile Networks (PLMNs) of NF service-consumers 305 (also referred to as “NF consumers 305”) into an NRF 303, according to an embodiment of the disclosure. In particular, FIG. 3 depicts an example representation of the NF producer 301 registering the policy profile into the NRF 303 for the PLMNs of the NF consumers 305.

The NF producer 301 corresponds to at least one of a Session Management Function (SMF), an Access and Mobility Management Function (AMF), a Unified Data Management (UDM), an Authentication Server Function (AUSF), a Policy Control Function (PCF), a Short Message Service Function (SMSF), a Location Management Function (LMF), a Network Slice Selection Function (NSSF), an Equipment Identity Register (EIR), a Unified Data Repository (UDR), a Charging Function (CHF), a Network Exposure Function (NEF) or any other types of network function that registers its services into the NRF 303. Similarly, each of the NF consumers 305 comprises at least one of the AMF, AUSF, NEF, PCF, SMF, UDM, CHF, EIR, LMF, a Session Plane Function (SPF), or any other types of NFs that discovers the NF producers via the NRF 303 or requests access-rights from the NRF 303.

The NF producer 301 is configured to determine a plurality of authorization parameters indicating one or more first type of access-rights of the NF consumers 305 that are authorized by the NF producer 301 and/or one or more second type of access-rights of the plurality of NF consumers that are unauthorized by the NF producer 301. The NF producer 301 determines the plurality of authorization parameters based on a plurality of network attributes associated with a plurality of NF consumers (i.e., properties of the NF consumers 305). The plurality of network attributes associated with the NF consumers 305 includes attributes corresponding to at least a PLMN, a Stand-alone Non-Public Network (SNPN), a Network Function Type (nfType), a Network Function Domain (NfDomain), Single Network Slice Selection Assistance Information (S-NSSAIs), and Network Function Instance Identity (NF-Instance Id).

Further, based on the determined plurality of authorization parameters, the NF producer 301 is configured to construct the policy profile including an authorization policy corresponding to each network attribute among the plurality of network attributes. Accordingly, the NF producer 301 registers the constructed policy profile including the authorization policy into the NRF 303. The NF producer 301 utilizes Nnrf_NFManagement_NFRegister service operation to register the constructed policy profile including the authorization policy into the NRF. In an embodiment of the disclosure, the NF producer 301 constructs the policy profile at each level of a plurality of levels within the communication network. The plurality of levels may include at least an NF, an NF-Service, an NF-Set, and an NFService-set.

For instance, in a non-limiting example, as shown in FIG. 3, an NF producer p1 registers the policy profile into the NRF 303 using the Nnrf_NFManagement_NFRegister service operation and thereafter the NF producer p1 provides the constructed policy profile including the authorization policy to the NRF 303.

In an embodiment of the disclosure, the authorization policy includes additional authorization parameters which comprise a list of rules to allow or restrict the NF consumers 305 from performing one or more operations on a platform of the NF producer 301. The list of rules corresponds to a map of rules indicating whether a corresponding NF consumer among the NF consumers 305 is allowed or denied for accessing one or more operation services provided by the NF producer 301.

In an embodiment of the disclosure, each rule among the list of rules comprises a priority associated with the rule, a list including the plurality of network attributes associated with the NF consumers 305, a list of operations allowed to be performed on the NF producer 301, and an action indicating whether a corresponding NF consumer among the NF consumers 305 is allowed or denied for accessing the one or more op-erations/services provided by the NF producer 301. In a non-limiting example, the rules may be represented such as:
Priority 1 plmn-id< >nfType < >nfInstance-id< >scopes < >allow
Priority 2 plmn-id< >nfType < >scopes < >allow
Priority 3 plmn-id< >nfType < >allow
Priority 4 deny

In an embodiment of the disclosure, the list including the plurality of network attributes may include one or more of a list of allowed PLMNs, a list of allowed SNPNs, a list of allowed nfTypes, a list of allowed NfDomains, a list of allowed S-NSSAIs, or a list of allowed NF-Instance Ids. For instance, in accordance with the example shown in FIG. 3, the constructed policy profile provided by the NF producer p1 to the NRF 303 may be configured as:
Priority 2 PLMN {PLMN2} nfType {A} allow,
Priority 5 PLMN {PLMN1} nfType {A,B} allow, and
Priority 100 deny.

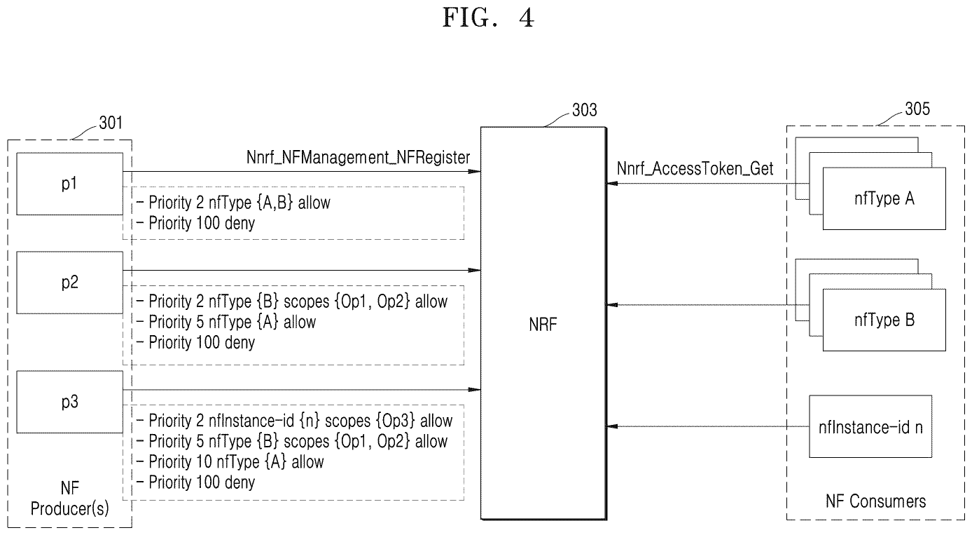

In an embodiment of the disclosure, FIG. 4 illustrates a second example representation depicting a registration process performed by the NF producer 301 to register a policy profile into the NRF 303 by providing additional authorization parameters, according to an embodiment of the disclosure. In a non-limiting example, as shown in FIG. 4, when NF producers, i.e., p1, p2, p3 register the policy profile into the NRF 303 utilizing the Nnrf_NFManagement_NFRegister service operation, each of the NF producers p1, p2, and p3 provide additional authorization parameters to the NRF 303. The additional authorization parameters provided by the NF producers p1, p2, and p3 to the NRF 303 comprise the following information:

A list of rules, each rule consisting of:
a. priority of the rule
b. A list of properties of the NF-Service-Consumers consisting of at least one of the following:
i. List of allowed PLMNs
ii. List of allowed SNPNs
iii. List of allowed nfTypes
iv. List of allowed S-NSSAIs
v. List of allowed nfDomains
vi. List of allowed nfInstance-ids
c. list of scopes
d. action allow/deny

According to an embodiment of the disclosure with reference to FIG. 4, when one of an NF consumer among the NF consumers 305 requests an Access-Token from the NRF 303, the NRF 303 matches the properties of that NF consumer against the rules of the policy profile in a decreasing order of priority (1 being the highest). If a match is found, the NRF 303 stops the search and the matching rule is applied to determine a scope to be granted to the NF consumer from which the Access-Token request is received. In a non-limiting example, for the NF Producer 301 (p1), two rules need to be configured:
a. Specifying that nfTypes={A,B} are allowed to access the NF Producer 301 (p1); and
b. Deny any other NF producer, where an absence of scope attribute in the rule definition indicates that the allowed NFs have unrestricted access.

In another non-limiting example, for the NF Producer 301 (p2), three rules need to be configured:
a. Specifying that nfTypes={B} is allowed restricted access;
b. Specifying that nfTypes={A} is allowed unrestricted access; and
c. Deny any other NF-Service-Producer.

Similarly, in another non-limiting example, for the NF Producer 301 (p3), four rules need to be configured:
a. One specifying that nfInstance-id={n} is allowed a certain restricted scope;
b. One specifying that nfTypes={B} is allowed a different restricted access;
c. One specifying that nfTypes={A} is allowed unrestricted access; and
d. Deny any other NF-Service-Producer.

Thus, in view of the above-described embodiments in conjunction with FIGS. 3 and 4, the amount of information the NF 301 configures in the NRF 303 may be reduced significantly in comparison to the amount of information the NF producer 301 needs to configure with the methods using prior-art techniques. Similarly, the amount of information NRF 303 needs to process to determine the final authorization scope granted to the NF consumers 305 reduces significantly. Similarly, the NF producer is able to register an authorization policy without having to allow unintended access to certain NF consumers.

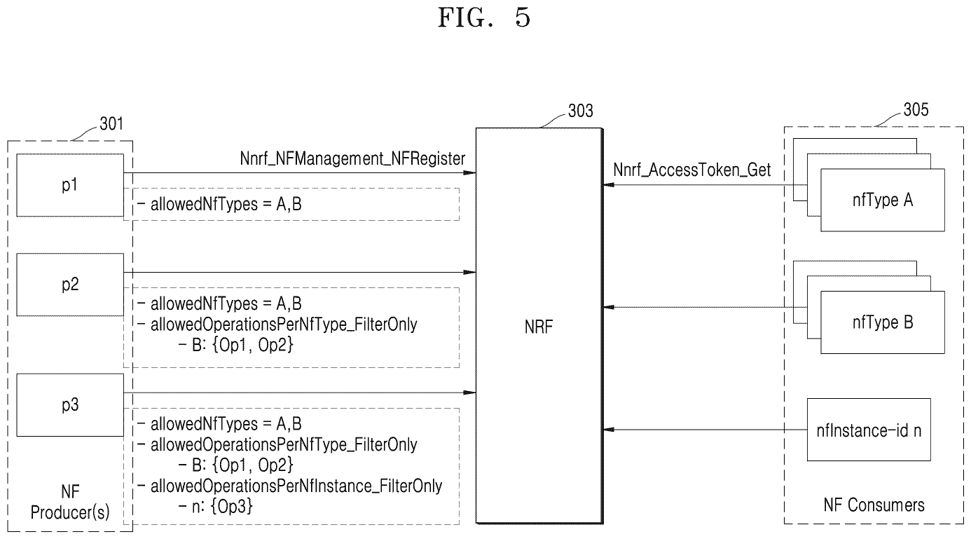

Referring now to FIG. 5 illustrates a third example representation depicting the registration process performed by the NF producer 301 to register the policy profile into the NRF 303 by providing additional authorization parameters, according to an embodiment of the disclosure. In an embodiment of the disclosure, when NF producer(s) 301 for example, p1, p2, and p3 may register the policy profile into the NRF 303 using the Nnrf_NFManagement_NFRegister service operation, then the NF producer(s) 301 provide additional authorization parameters to the NRF 303. The additional authorization parameters may indicate the operations the NF consumers 305 are allowed to perform on the platform of the NF producer(s) 301. In this aspect, the authorization parameters are defined similarly to existing parameters allowedOperationsPerNfType and/or allowedOperationsPerNfInstance and are defined as per Nf-Type and/or per NF-Instance granularity. Furthermore, if the nfType and/or nfInstanceID of the NF consumers 305 does not belong to the one indicated in the new authorization parameters, the new authorization parameters are ignored, and the NF consumers may be granted the Access-Token based on other existing authorization parameters.

This aspect differentiates them from the existing parameters allowedOperationsPerNfType and/or allowedOperationsPerNfInstance in the prior art, as those parameters are not ignored in such a scenario, and the NF consumers 305 cannot be granted the Access-Token based on matching with other existing authorization parameters. The information could be configured at the NF and/or NF-Service and/or NF-Set and/or NF-Service-Set level.

In an example in accordance with FIG. 5, there is no change in the policy profile of the NF producer 301 (p1). In another example in accordance with FIG. 5, the NF producer 301 (p2) may now need to register only the new authorization policy containing allowed operations for nfType=B. Further, to take care of NF consumers belonging to nfType=A having unrestricted access, and thus the NF consumers belonging to nfType=A need to register the existing parameter allowedNfTypes={A, B}. In yet another example in accordance with FIG. 5, the NF producer 301 (p3) now needs to register only the new authorization policy containing allowed-operations for instance-id=n, a new authorization policy containing allowed-operations for nfType=B. Further, to take care of the NF consumers belonging to nfType=A having unrestricted access, the NF consumers belonging to nfType=A need to register the existing parameter allowedNfTypes={A, B}.

Hence, based on the policy profile configuration as described above with respect to FIGS. 3 through 5, the amount of information the NF producer(s) 301 configure in the NRF 303 reduces significantly. Similarly, the amount of information the NRF 303 needs to process to determine the final authorization scope granted to the NF consumers 305 also reduces significantly.

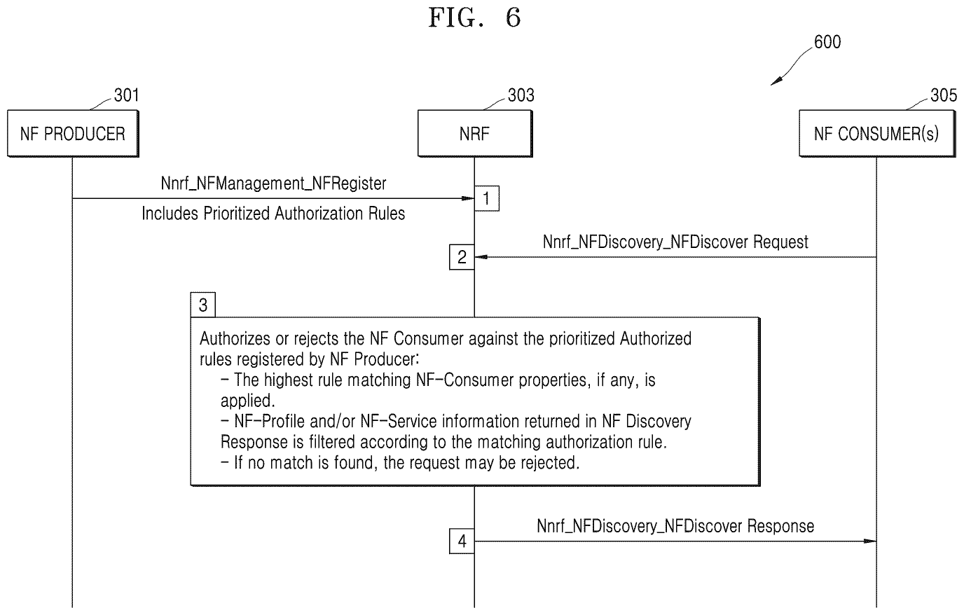

FIG. 6 illustrates a line diagram depicting a method 600 implemented at the NRF 303 for allowing discovery of one or more NF producers (i.e., NF producer 301), according to an embodiment of the disclosure. The method 600 includes a series of operation steps 1 through 4.

The method 600 begins at operation step 1, at which the NF producer 301 registers the policy profile including the authorization policy into the NRF 303. The NF producer 301 utilizes the Nnrf_NFManagement_NFRegister service operation for registering the policy profile. Further, as discussed above with reference to FIGS. 3 through 5 that the authorization policy includes the list of rules to allow or restrict the NF consumers 305 from performing one or more operations on the platform of the NF producer 301.

At operation step 2, the NRF 303 receives a request for discovery of the NF producer 301 matching a set of capabilities from the NF consumer 305.

At operation step 3, the NRF 303 authorizes or rejects the request of the NF consumer 305 against a prioritized authorized rule registered by the NF producer 301. For authorizing or rejecting the NF consumer 305 against the prioritized authorized ruled registered by the NF producer 301 may include a plurality of steps including determining, in response to the received request, one or more network attributes associated with the NF consumer 305, and thereafter mapping the determined one or more network attributes with authorization rules that are registered by the NF producer 301 into the NRF 303. The plurality of steps further includes determining, based on a result of the mapping, highest priority authorization rule containing network attributes of the NF consumer 305. The method includes determining, upon the determination of the highest priority authorization rule, whether the NF producer 301 and/or NF services of the NF producer 301 are allowed or denied to be discovered by the NF consumer 305. If it is determined that the NF producer 301 and/or NF services of the NF producer 301 are allowed, then the NRF 303 authorizes the request from the NF consumer 305 against the prioritized authorized rules registered by the NF producer 301 into the NRF 303. If it is determined that the NF producer 301 and/or NF services of the NF producer 301 are denied, then the NRF 303 rejects the request from the NF consumer 305 against the prioritized authorized rules registered by the NF producer 301 and such NF producer is not included in the discovery result.

At operation step 4, the NRF 303 sends, to the NF consumer 305, a discovery result containing a list of NF producers and allowed NF services of the NF producers that are included in the list. The allowed NF services are services that can be accessed by the NF consumer 305. Further, the request for the discovery of the one or more NF producers matches a set of capabilities from the NF consumer 305 and uses Nnrf_NFDiscovery_NFdiscover service operation for sending the discovery result to the NF consumer 305.

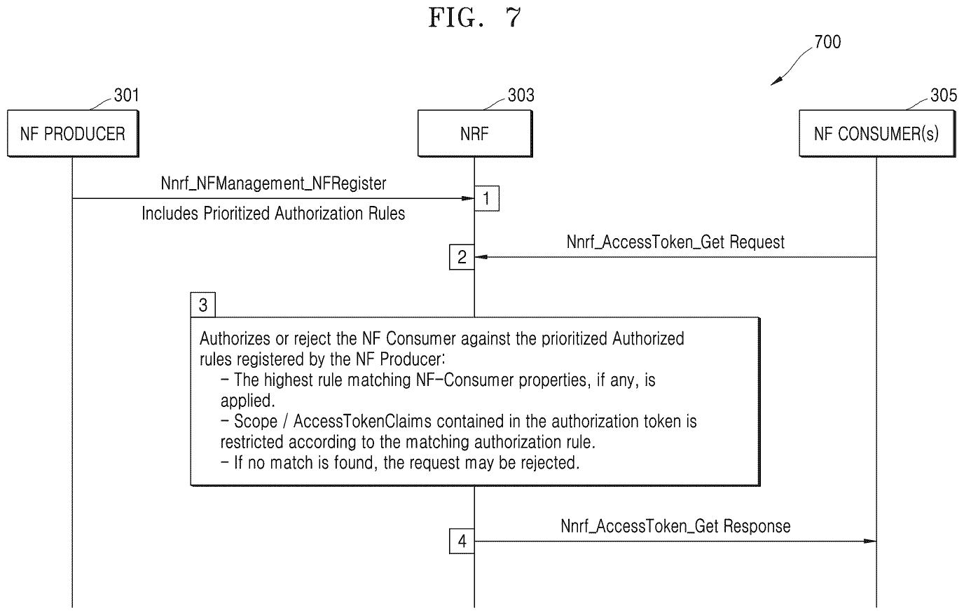

FIG. 7 illustrates a line diagram depicting a method implemented at the NRF 303 for allocating or denying an Access-Token to the NF consumer 305, according to an embodiment of the disclosure.

The method starts at operation step 1 of FIG. 7. At operation step 1, the NF producer 301 registers the policy profile including the authorization policy into the NRF 303. The NF producer 301 utilizes the Nnrf_NFManagement_NFRegister service operation for registering the policy profile.

At operation step 2, the NRF 303 receives a request for the Access-Token from the NF consumer 305. In one example, the request for the Access-Token from the NF consumer 305 utilizes Nnrf_AccessToken_Get service operation.

At operation step 3, the NRF 303 authorizes or rejects the request of the NF consumer 305 against a prioritized authorized rule registered by the NF producer 301. For authorizing or rejecting the request of the NF consumer 305 against the prioritized authorized ruled registered by the NF producer 301 includes a plurality of steps including determining, in response to the received request, one or more network attributes associated with the NF consumer 305, and thereafter mapping the determined one or more network attributes with authorization rules that are registered by the NF producer 301 into the NRF 303. The plurality of steps further includes determining, based on a result of the mapping, highest priority authorization rule containing network attributes of the NF consumer 305. Thereafter, the plurality of steps including determining, upon the determination of the highest priority authorization rule, at least one Access-Token claim based on a scope of authorization and action in the highest priority authorization rule.

At operation step 4, the NRF 303 allocates the Access-Token to the NF consumer 305 based on the at least one Access-Token claim.

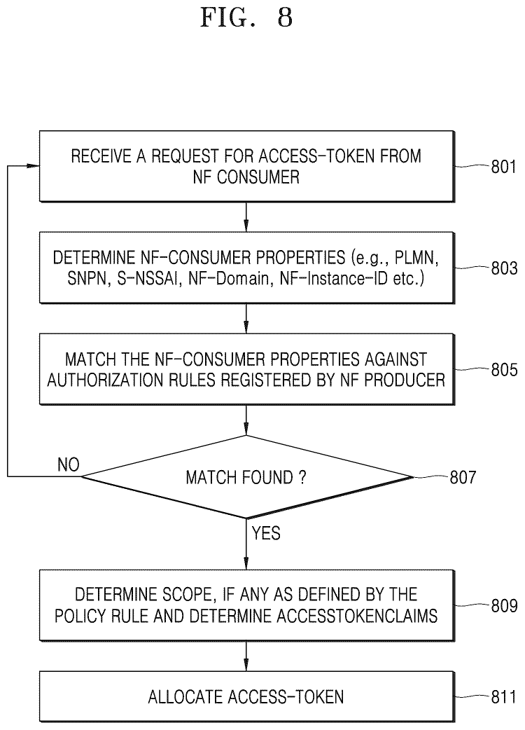

FIG. 8 illustrates a detailed method flow chart depicting the method for allocating or denying the Access-Token to the NF consumer 305, according to an embodiment of the disclosure.

The method shown in FIG. 8 begins at block 801. At block 801, the NRF 303 receives the request for the Access-Token from the NF consumer 305.

At block 803, the NRF 303 determines the properties of the NF consumer 305, for example, PLMN, SNPS, S-NSSAI, NF-Domain, NF-instance-ID etc.

At block 805, the NRF 303 matches the properties of the NF consumer 305 against the authorization rules registered by the NF producer 301 into the NRF 303.

At block 807, the NRF 303 determines whether the properties of the NF consumer 305 match the authorization rules registered by the NF producer 301 into the NRF 303. If the match is found, then the method proceeds to block 809. Further, if the match is not found, the method proceeds to block 801 and operations corresponding to blocks 801 through 807 are repeated by the NRF 303 until the match is found.

At block 809, the NRF 303 determines each of the scopes, if any as defined by the policy rule and determines AccessTokenClaims for the NF consumer 305.

At block 811, the NRF 303 allocates the Access-Token to the NF consumer 305 based on the scope present in the policy rule.

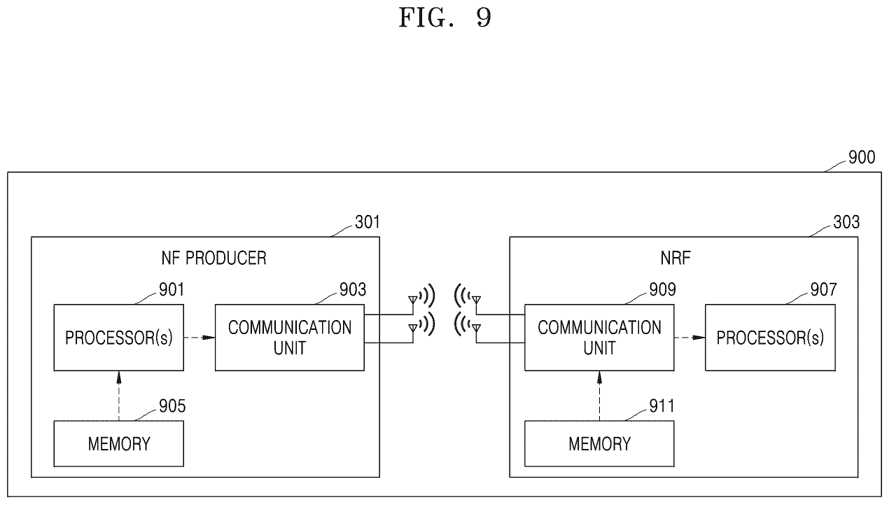

FIG. 9 illustrates an example block diagram of a communication environment depicting a configuration of the NF producer 301 and the NRF 303 in a wireless communication network 900, according to an embodiment of the disclosure. The config-urations as disclosed in FIG. 9 may be understood as parts of the configuration of the NF producer 301 and the NRF 303. Hereinafter, it is understood that terms including “unit” or “module” at the end may refer to the unit for processing at least one function or operation and may be implemented in hardware, software, or a combination of hardware and software.

Referring to FIG. 9, the NF producer 301 may include one or more processor(s) 901 (also, referred to as processor 901), a communication unit 903 (e.g., communicator or communication interface), and a storage unit (e.g., memory 905). By way of example, the NF producer 301 may correspond to at least one of the MF, AMF, UDM, AUSF, PCF, SMSF, LMF, NSSF, EIR, UDR, CHF, NEF or any other types of network function that registers its services into the NRF 303. The communication unit 903 may perform functions for transmitting and receiving signals.

As an example, the processor 901 may be a single processing unit or a number of units, all of which could include multiple computing units. The processor 901 may be implemented as one or more microprocessors, microcomputers, microcontrollers, digital signal processors, central processing units, state machines, logic circuitries, and/or any devices that manipulate signals based on operational instructions. Among other capabilities, the processor 901 is configured to fetch and execute computer-readable instructions and data stored in the memory. The processor 901 may include one or a plurality of processors. At this time, one or a plurality of processors 901 may be a general-purpose processor, such as a central processing unit (CPU), an application processor (AP), or the like, and an AI-dedicated processor such as a neural processing unit (NPU). The processor 901 may control the processing of input data in accordance with a predefined operating rule or artificial intelligence (AI) model stored in the non-volatile memory and the volatile memory, i.e., the memory 905. The predefined operating rule or artificial intelligence model is provided through training or learning.

The memory 905 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

Further, the NRF 303 may also include one or more processor(s) 907 (also, referred to as processor 907), a communication unit 909 (e.g., communicator or communication interface), and a storage unit (e.g., memory 911). The communication unit 909 may perform functions for transmitting and receiving signals. The functionalities and features of the processor 907, communication unit 909, and memory 911 may be similar to those of the processor 901, communication unit 903, and memory 905, re-spectively. Therefore, a detailed explanation of the same is omitted herein for the sake of brevity of the present disclosure.

The method disclosed herein provides various technical advantages and benefits such as helps in significantly reducing the amount of information that the NF producer(s) 301 configure in the NRF 303. This further helps in significantly reducing the amount of information the NRF 303 needs to process to determine final authorization scope granted to the NF consumers.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The below table includes a list of abbreviations and acronyms that are being used in the description of the present disclosure:

TABLE 2

| Abbreviation | Explanation |
|---|---|
| NRF | Network Repository Function |
| NF | Network Function |
| 3GPP | 3rd Generation Partnership Project |
| NSSAI | Network Slice Selection Assistance Information |
| S-NSSAI | Single-Network Slice Selection Assistance |
| | Information |
| NF-Type | Type of Network Function (e.g., AMF, SMF, NEF) |
| PLMN | Public Land Mobile Network |
| SNPN | Standalone Non-Public Network |
| NSI | Network Slice Instance |
| ID | Identifier |
| URI | Uniform Resource Identifier |
| AMF | Access and Mobility Function |
| UDM | Unified Data Management |
| UE | User Equipment |

1-15. (canceled)

16. A method performed by a Network Repository Function (NRF) in a wireless communication network, the method comprising:
receiving, from a Network Function (NF) producer, a NF profile including a ruleset, wherein the ruleset indicates whether a NF consumer is allowed to access the NF producer;
receiving, from the NF consumer, a request message for an access token;
matching at least one property of the NF consumer against at least one rule included in the ruleset; and
determining a scope that is allowed to the NF consumer, based on a result of the matching.

17. The method of claim 16, wherein the at least one rule comprises at least one of:
a priority of a rule, information of a Public Land Mobile Network (PLMN) to be allowed,
information of a Standalone Non-Public Network (SNPN) to be allowed,
information of a Network Function Type (nfType) to be allowed,
information of a Network Function Domain (NfDomain) to be allowed,
information of a Single-Network Slice Selection Assistance Information (S-NSSAI) to be allowed,
information of a Network Function Instance Identity (NF-Instance Id) to be allowed,
information of the scope to be allowed, and
information of an action to be allowed or denied.

18. The method of claim 17, wherein the determining of the scope comprises:
in case that the information of the scope is absent, determining that the NF consumer is allowed or denied to all the scopes.

19. The method of claim 16, wherein the at least one property of the NF consumer comprises at least one of a PLMN, a SNPN, a nfType, a NfDomain, a S-NSSAI, and a NF-Instance Id.

20. The method of claim 17, wherein the matching of the at least one attribute of the NF consumer against the at least one rule comprises:
matching the at least one property of the NF consumer against the at least one rule in a decreasing order of the priority.

21. The method of claim 16, further comprising:
in case that a matching rule is found, stopping a search.

22. The method of claim 16, wherein the NF profile is registered into the NRF by the NF producer.

23. The method of claim 16, further comprising:
in response to the request message, transmitting, to the NF consumer, a response message including the access token, wherein the access token comprises the determined scope to be allowed to the NF consumer.

24. A Network Repository Function (NRF) comprising:
a transceiver; and
at least one processor coupled to the transceiver, configured to:
receive, from a Network Function (NF) producer, a NF profile including a ruleset, wherein the ruleset indicates whether a NF consumer is allowed to access the NF producer,
receive, from the NF consumer, a request message for an access token,
match at least one property of the NF consumer against at least one rule included in the ruleset,
determine a scope that is allowed to the NF consumer, based on a result of the matching.

25. The NRF of claim 24, wherein the at least one rule comprises at least one of:
a priority of a rule, information of a Public Land Mobile Network (PLMN) to be allowed,
information of a Standalone Non-Public Network (SNPN) to be allowed,
information of a Network Function Type (nfType) to be allowed,
information of a Network Function Domain (NfDomain) to be allowed,
information of a Single-Network Slice Selection Assistance Information (S-NSSAI) to be allowed,
information of a Network Function Instance Identity (NF-Instance Id) to be allowed,
information of the scope to be allowed, and
information of an action to be allowed or denied.

26. The NRF of claim 25, wherein the at least one processor is configured to:
in case that the information of the scope is absent, determine that the NF consumer is allowed or denied to all the scopes.

27. The NRF of claim 24, wherein the at least one property of the NF consumer comprises at least one of a PLMN, a SNPN, a nfType, a NfDomain, a S-NSSAI, and a NF-Instance Id.

28. The NRF of claim 25, wherein the at least one processor is configured to:
match the at least one property of the NF consumer against the at least one rule in a decreasing order of the priority.

29. The NRF of claim 25, wherein the at least one processor is further configured to:
in case that a matching rule is found, stop a search.

30. The NRF of claim 24, wherein the NF profile is registered into the NRF by the NF producer.

31. The NRF of claim 24, wherein the at least one processor is further configured to:
in response to the request message, transmit, to the NF consumer, a response message including the access token, wherein the access token comprises the determined scope to be allowed to the NF consumer.
